(19) United States
(12) Patent Application Publication
(10) Pub. No.: US 2018/0260917 A1
(43) Pub. Date: Sep. 13, 2018

(54) SYSTEM AND A METHOD FOR PROVIDING COMMUNICATION BETWEEN REAL ESTATE CONSUMERS AND REAL ESTATE PROFESSIONALS

(71) Applicants: Matthew Simons, South Lyon, MI (US); Timothy Street, Merritt Island, FL (US); Jared Barrus, Sandy, UT (US); David Ellerstein, Delray Beach, FL (US); Matthew Barrus, Draper, UT (US)

(72) Inventors: Matthew Simons, South Lyon, MI (US); Timothy Street, Merritt Island, FL (US); Jared Barrus, Sandy, UT (US); David Ellerstein, Delray Beach, FL (US); Matthew Barrus, Draper, UT (US)

(21) Appl. No.: 15/454,192

(22) Filed: Mar. 9, 2017

(51) Int. Cl. G06Q 50/16; H04W 4/14; H04L 12/58; H04L 29/08; H04L 29/06; G06Q 30/06

(52) U.S. Cl. CPC G06Q 50/16; H04W 4/14; H04L 51/046; H04L 51/20; H04L 67/02; H04L 67/42; H04L 51/26; H04L 65/1069; H04L 67/12; H04L 51/063; G06Q 30/0613; H04L 51/36

(57) ABSTRACT

Disclosed is a method and a system for allowing real-time communication between real estate communication between real estate consumers and real estate professionals. The method includes the step of receiving a communication request from a real estate consumer for interacting with a real estate professional, extracting the zip code of the real estate viewed by the real estate consumer, creating a team of real estate professionals belonging to the same zip code, associating the zip code with the team of real estate professionals of the same zip code, converting the communication request into a text message, sending the text message in a hierarchy to each real estate professional of the associated team, receiving acceptance from the first real estate professional in the hierarchy to communicate with the real estate consumer, converting the text message received from the first real estate professional into the web communication message and displaying the response of the first real estate professional to the real estate consumer to establish the communication.

### BACKGROUND OF THE INVENTION

### 1. Field of the Invention

The present invention generally relates to a system for facilitating communication between real estate consumers and real estate professionals, and more particularly relates to a system integrating with a real estate web platform for allowing real-time communication between real estate consumers and real estate professionals.

### 2. Description of Related Art

Most real estate web sites today must continue to rely on web forms to service consumer requests and gauge consumer interest. A real estate consumer who submits a web form is often followed up by a real estate professional later. The process falls short of the expectation of today's consumer for instant gratification.

Many of the web site chat products on the market today could solve this challenge, allowing real estate organizations to service consumer requests in real-time from their web sites. However, the chat products today fail to address the challenges that are unique to real estate organizations and real estate professionals.

First, real estate organizations are primarily driven by a mobile work-force. The daily routine of a real estate professional often require them to be away from the office, which is where the majority of their inbound sales leads wind up. Because of this, real estate professionals are not able to consistently engage with their computers in service of chat conversations from web site visitors.

Second, real estate agents are often in situations where they cannot answer an incoming phone call or text messages or web site chat conversations, such as listing appointments or closings, causing these inbound opportunities to go non-serviced.

Thirdly, most real estate organizations will service a large geographic market. In the case when a visitor submits a web form, the real estate organization can often assign the opportunity to the real estate professional best positioned to service that consumer. However, the chat products on the market today do not contain the intelligence necessary to ensure live chat conversations are serviced by the appropriate real estate professionals.

Therefore, there is a need to provide a system for initiating instant communication between the web site visitor and the real estate professional that is both intelligent enough to identify those real estate professionals best positioned to service the consumer, and flexible enough to overcome the sporadic availability of today's real estate professional.

### SUMMARY OF THE INVENTION

In accordance with a preferred embodiment of the present invention, a system for initiating instant communication in between the visitor and the real estate professional over the communication network is provided.

An object of the present invention is to provide a machine readable non-transitory medium storing executable program instruction which when executed cause a data processing system to perform a method for allowing real-time communication between real estate communication between real estate consumers and real estate professionals.

The method includes the step of receiving a communication request from a real estate consumer for interacting with a real estate professional, extracting the zip code of the real estate viewed by the real estate consumer, creating a team of real estate professionals belonging to the same zip code, associating the zip code with the team of real estate professionals of the same zip code, converting the communication request into a text message, sending the text message in a hierarchy to each real estate professional of the associated team, receiving acceptance from the first real estate professional in the hierarchy to communicate with the real estate consumer, converting the text message received from the first real estate professional into the web communication message and displaying the response of the first real estate professional to the real estate consumer to establish the communication.

Another object of the present invention is to provide the method with a step of sending the text message from the real estate consumer to the second real estate professional in the hierarchy on failure to receive the response from the first real estate professional in a pre-defined time.

Another object of the present invention is to provide the method with steps of sending the text message received from the real estate consumer simultaneously to each real estate professional in a team associated with the extracted zip code, receiving a text message response from at least one of the real estate professional from the team, and convert the text message into the web chat of the real estate professional who responded first and within the pre-defined time to establish communication with the real estate consumer.

Another object of the present invention is to provide the method with steps of sending the text message received from the real estate consumer to each real estate professional in a second group associated with the extracted zip code upon failure to receive response from each real estate professional of the first group within the pre-defined time.

Another object of the present invention is to provide a system integrating with a real estate platform for allowing real-time communication between real estate consumers and real estate professionals. The system includes a server, a processor coupled to the server, and a software module stored on the server and executed by the processor.

The server includes a real estate professional database for storing data such as zip code of real estate professionals in a hierarchy for responding within a pre-defined time to web chat request initiated by the real estate consumers, a real estate professional team database coupled to the real estate professional database for storing data of one or more teams of real estate professionals in a hierarchy associated with zip codes of a real estate and a real estate professional group database coupled to the real estate professional team database for storing data of real estate professionals in groups in a hierarchy belonging to same zip code of a real estate. The software module stores the step disclosed in the method and the processor executes the step disclosed in the method.

These and other features and advantages will become apparent from the following detailed description of illustrative embodiments thereof, which is to be read in connection with the accompanying drawings.

### BRIEF DESCRIPTION OF DRAWING

The disclosure will provide details in the following description of preferred embodiments with reference to the following figures wherein:

FIG. 1 illustrates a flowchart of a method for allowing real-time communication between real estate consumers and real estate professionals in accordance with a preferred embodiment of the present invention;

FIG. 2 illustrates a block diagram of a system for integrating with a real estate web platform for allowing real-time communication between real estate consumer and real estate professional;

FIG. 3 illustrates a schematic diagram to show flow of the text message received from the real estate consumer within the team, group and real estate professional;

FIG. 4 illustrates a screenshot showing of a real estate web platform in accordance with a preferred embodiment of the present invention;

FIG. 5 illustrates a screenshot showing of a smartphone screen displaying association of the real estate consumer with the real estate professional in accordance with a preferred embodiment of the present invention; and

FIG. 6 illustrates a screenshot showing a real estate web platform displaying communication between the real estate consumer and the real estate professional.

### DETAILED DESCRIPTION OF DRAWINGS

While this technology is illustrated and described in a preferred embodiment, a system and a method for allowing real-time communication between real estate consumers and real estate professionals may be produced in many different configurations, forms and computer languages. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

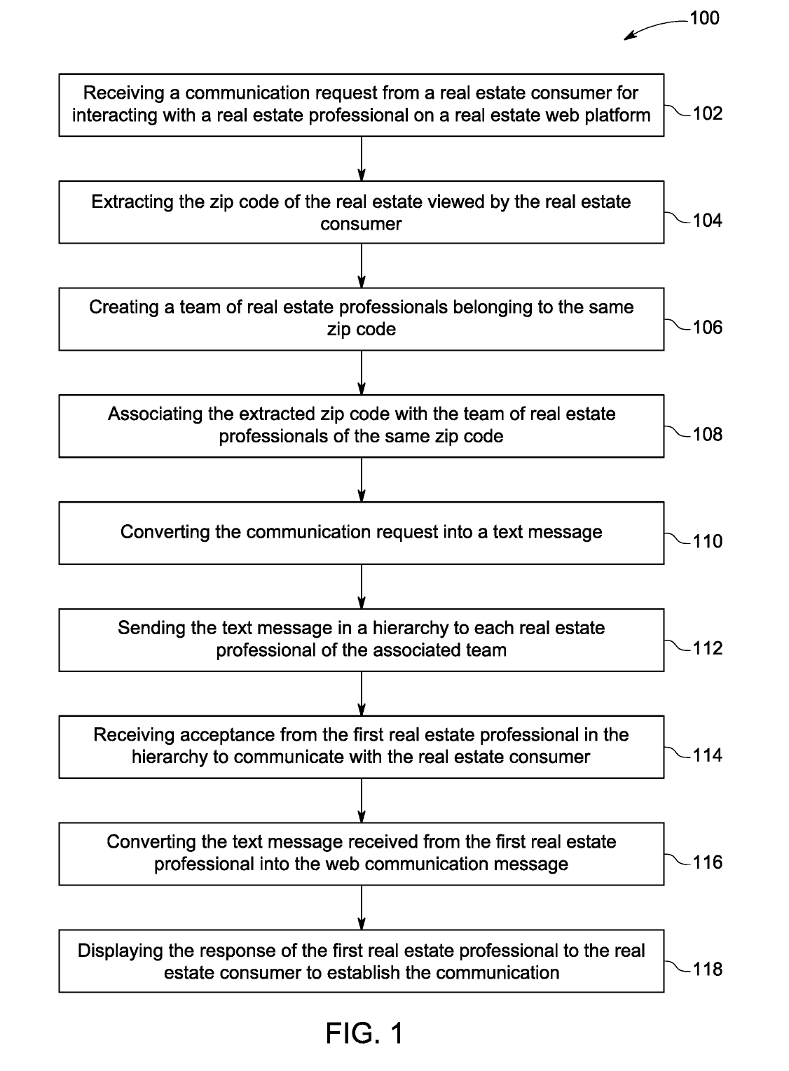

FIG. 1 illustrates a flowchart of a method 100 for allowing real-time communication between real estate consumers and real estate professionals in accordance with a preferred embodiment of the present invention. The method 100 initiates with a step 102 of receiving a communication request from a real estate consumer for interacting with a real estate professional. In a preferred embodiment of the present invention, the real estate consumer visits the real estate web platform and initiates communication with the real estate professional to inquire about the real estate displayed on the real estate web platform.

The step 102 is followed by a step 104 of extracting the zip code of the real estate viewed by the real estate consumer. The zip code is automatically extracted from the web page from where the real estate consumer requested the web chat to interact with the real estate professional.

The step 104 is then followed by a step 106 of creating a team of real estate professionals belonging to the same zip code. A list of team of real estate professionals belonging to the same zip code is created and is stored in the database. The step 106 is then followed by a step 108 of associating the extracted zip code with the team of real estate professionals of the same zip code.

The step 108 is then followed by a step 110 of converting the communication request into a text message. The communication request is a web based message. The communication request is then converted into the text message. In a preferred embodiment the text message is a SMS. However, it would be readily apparent to those skilled in the art that various type of text message may be converted without deviating from the scope of the present invention.

The step 110 is then followed by a step 112 of sending the text message in a hierarchy to each real estate professional of the associated team. In a preferred embodiment of the present invention, the text message is send to on the mobile phone of the real estate professional.

For exemplary purposes, the real estate consumer is interested in a real estate located in California—94104. Then, the real estate consumer requests a communication with the real estate professional. The communication request is converted into the text message and is then send on the mobile phone of each real estate professional who are doing business in the 94104 area.

The step 112 is then followed by a step 114 of receiving acceptance from the first real estate professional in the hierarchy to communicate with the real estate consumer. The real estate professionals are stored in the hierarchy in the database. The first real estate professional accepts the communication request to initiate communication with the real estate consumer.

The step 114 is then followed by a step 116 of converting the text message received from the first real estate professional into the web communication message. The text message received from the first real estate professional is converted back in the web communication message i.e. internet chat message.

The step 116 is then followed by a step 118 of displaying the response of the first real estate professional to the real estate consumer to establish the communication. The internet chat message is displayed on the real estate web platform for initiating the conversation in between the real estate consumers and the real estate professionals.

In another preferred embodiment of the present invention, the method 100 further includes a step of sending the text message from the real estate to the second real estate professional in the hierarchy on failure to receive the response from the first real estate professional in a pre-defined time.

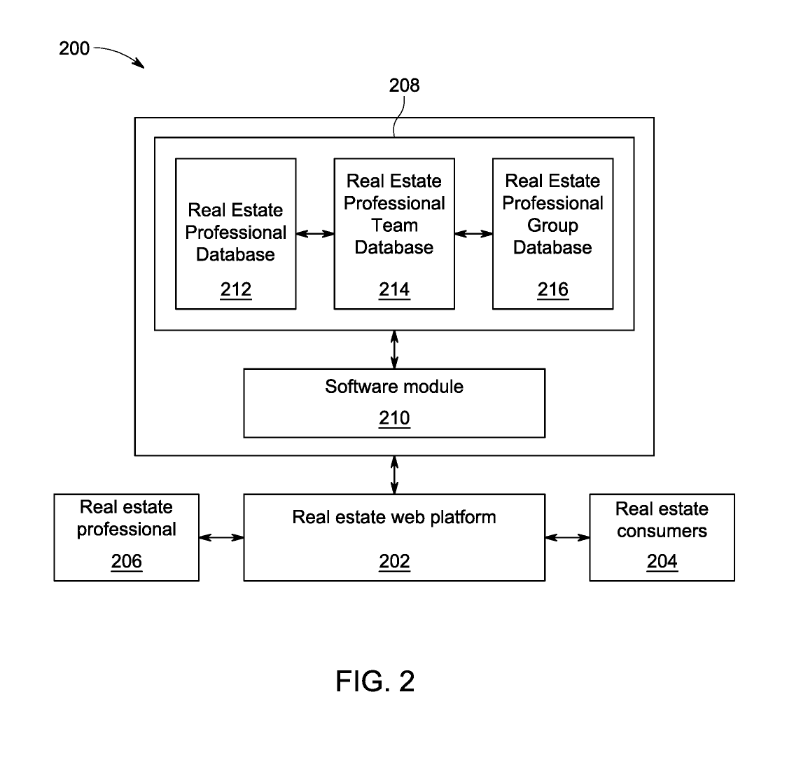

FIG. 2 illustrates a block diagram of a system 200 for integrating with a real estate web platform 202 for allowing real-time communication between real estate consumer 204 and real estate professional 206. The system 200 includes a server 208 and a software module 210 stored and executed by the server 208.

The server 208 includes a real estate professional database 212, a real estate professional team database 214, and a real estate professional group database 216. The real estate professional database 212 storing data such as zip code of real estate professionals in a hierarchy for responding within a pre-defined time to web chat request initiated by the real estate consumers.

The real estate professional team database 214 coupled to the real estate professional database 212 for storing data of one or more teams of real estate professionals in a hierarchy associated with zip codes of a real estate. The real estate professional group database 216 coupled to the real estate professional team database 214 for storing data of real estate professionals in groups in a hierarchy belonging to same zip code of a real estate.

The software module 210 is stored and executed by the server 208 to receive a web chat request from a real estate consumer for interacting with a real estate professional. The receiving of web chat request is explained in detail in conjunction with the step 102 of FIG. 1 of the present invention.

The software module 210 further includes a step to extract the zip code associated with the real estate for which the real estate consumer initiates the web chat request and followed by a step to convert the web chat request into a text message. The extraction of zip code and conversion of web chat request is explained in detail in conjunction with the step 104 and the step 110, respectively of FIG. 1 of the present invention.

The software module 210 further includes a step to send the text message received from the real estate consumer in a hierarchy to a first real estate professional associated with zip code of the real estate. Further, the above step is followed by another step to receive acceptance from the first real estate professional in the hierarchy to communicate with the real estate consumer within the pre-defined time.

The step of sending the text message and the step of receiving acceptance from the first real estate professional is explained in detail in conjunction with the step 112 and the step 114, respectively of the FIG. 1 of the present invention. The above step is then followed by a step to convert the text message received from the first real estate professional into the web chat message.

Further, the above step is followed by another step of displaying the response of the first real estate professional to the real estate consumer to establish the communication. The step to convert the text message and the displaying the response is explained in detail in conjunction with the step 116 and the step 118 of FIG. 1 respectively of the present invention.

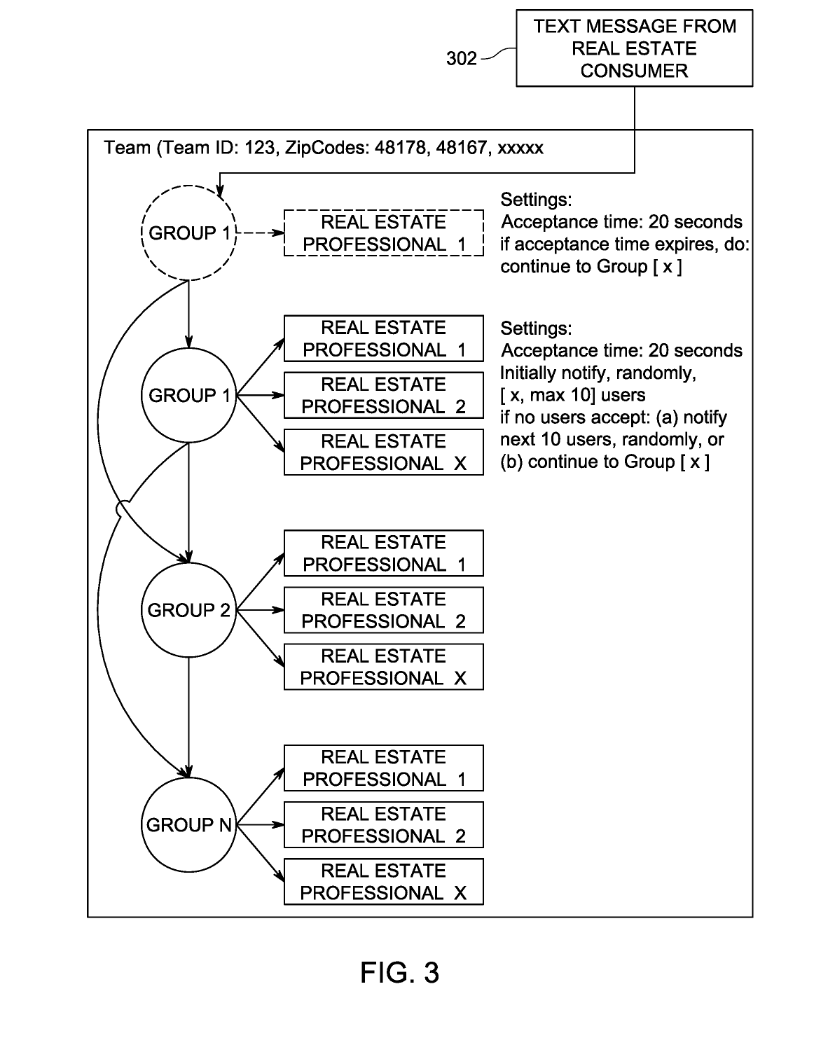

FIG. 3 illustrates a schematic diagram to show flow of the text message 302 received from the real estate consumer within the team, group and real estate professional. The text message 302 relates to a real estate property of a specific zip code. The text message 302 is first send to the GROUP 1 of the Team associated with the extracted zip code.

Thereafter, the Real Estate Professional 1 of the GROUP 1 gets a pre-defined time to respond to the text message 302. The Real Estate Professional 1 initiates communication with the real estate consumer upon responding to the text message within the pre-defined time. In a preferred embodiment of the present invention, the pre-defined time is 20 seconds.

In another preferred embodiment of the present invention, the Real Estate Professional 2 gets to reply to the text message 302 in case the Real Estate Professional 1 fails to reply within the pre-defined time. The Real Estate Professional 2 again has 20 seconds to respond to the text message 302.

Thus, the process is continued till the time any of the real estate professional from the GROUP 1 responds within the pre-defined time. Thereafter, the text message 302 is send to GROP 2 upon failure to receive the response of the text message 302 from each of the real estate professional in the GROUP 1 in the pre-defined time.

Further in another preferred embodiment of the present invention, the text message 302 is send simultaneously to each real estate professional in GROUP 1. The real estate professional who responds first and within the pre-defined time gets the first opportunity to communicate with the real estate consumer. The text message 302 is then send simultaneously to each real estate professional of GROUP 2 upon failure to receive the response on the text message 302 from any of the real estate professional within the pre-defined time.

Further in another preferred embodiment of the present invention, the text message 302 is send simultaneously to each real estate professional in GROUP N upon failure to receive response of the text message 302 from the GROUP 2 within the pre-defined time. It would be readily apparent to those skilled in the art that N number of groups may be associated with a TEAM without deviating from the scope of the present invention.

Further it would be readily apparent to those skilled in the art that N number of real estate professional may be associated with the GROUP without deviating from the scope of the present invention. The pre-defined time is generally kept low like 20 seconds to speed up the process of providing response to the real estate consumer from the right real estate professional.

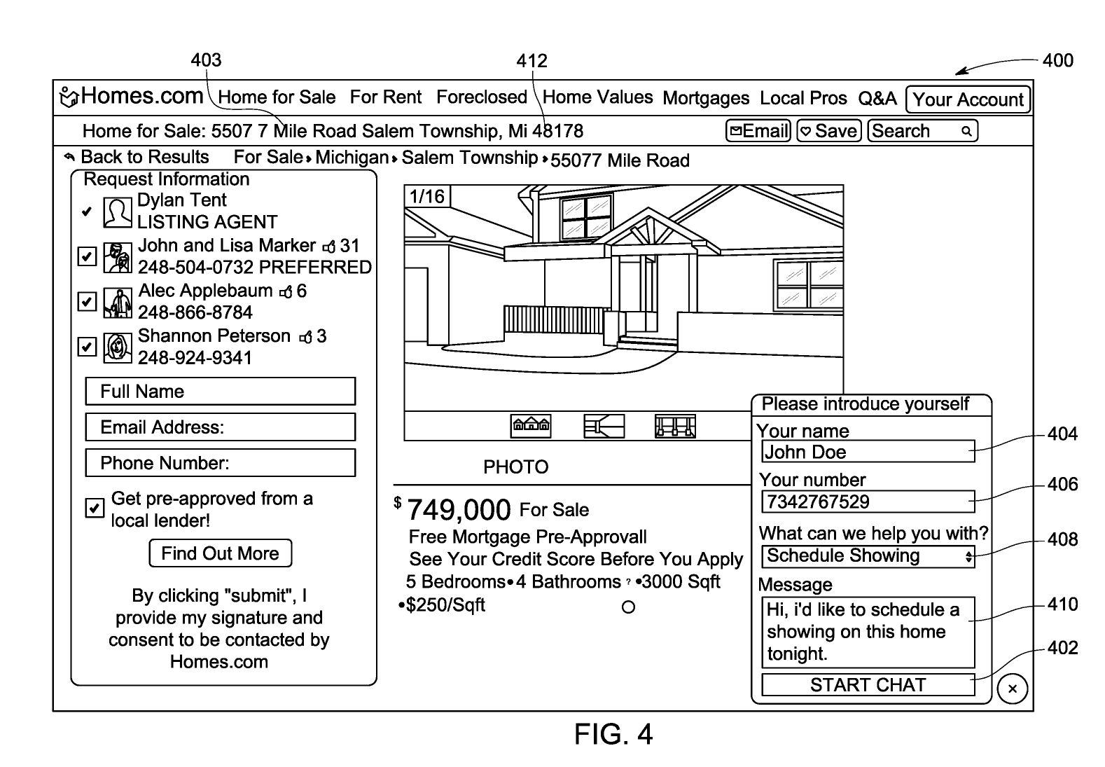

FIG. 4 illustrates a screenshot showing of a real estate web platform 400 in accordance with a preferred embodiment of the present invention. The real estate consumer sends a communication request 402 to a real estate agent through the real estate web platform 400 on visiting the web page of the interested real estate 403. The real estate consumer provides information such as Name 404, Number 406, Purpose 408 and Message 410.

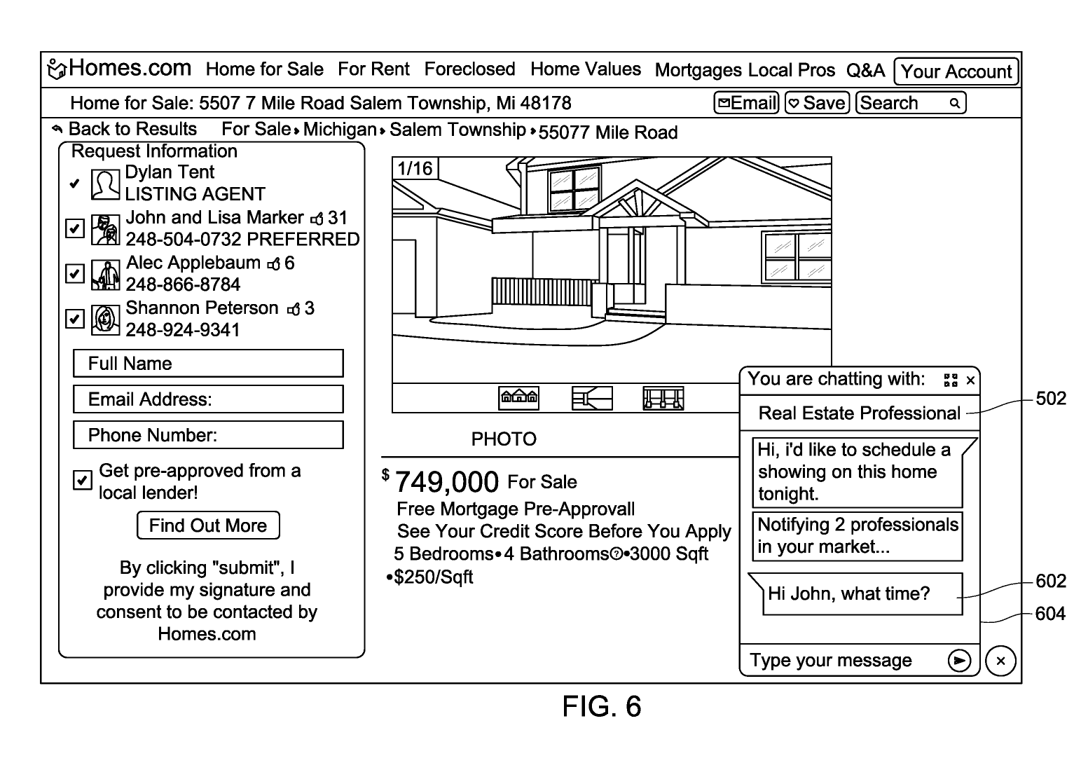

The real estate web platform 400 then extracts the zip code 412 of the interested real estate 403. The system then extracts the zip code and then associates the real estate consumer with the real estate professionals taking care of real estates in the extracted zip code 412. The association of the real estate consumer with the real estate professionals is explain in detailed in conjunction with FIG. 6 of the present invention.

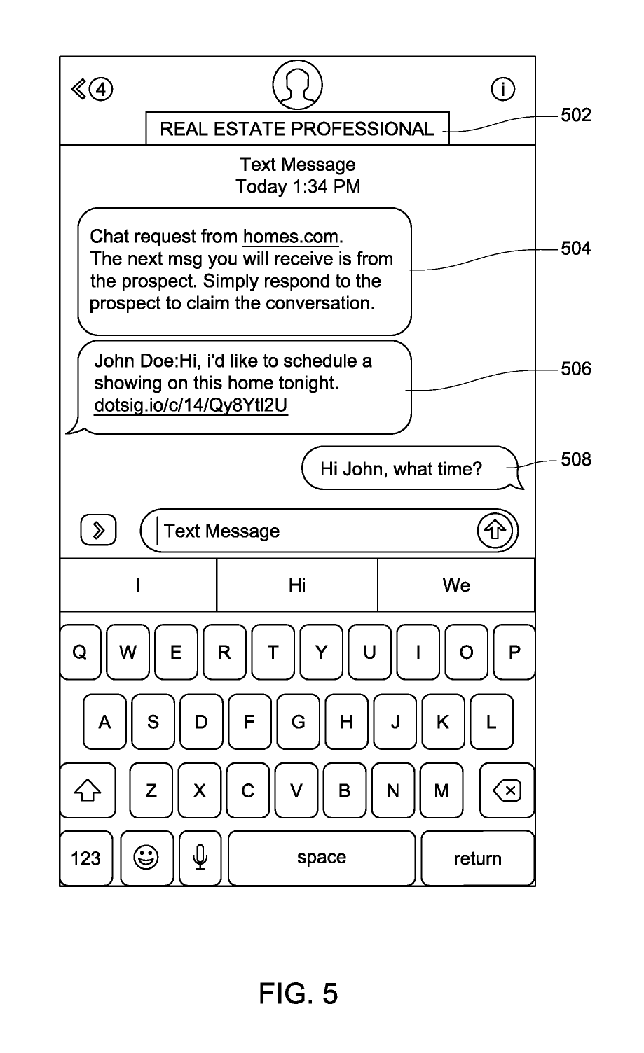

FIG. 5 illustrates a screenshot showing of a smartphone screen displaying association of the real estate consumer with the real estate professional 502 in accordance with a preferred embodiment of the present invention. The system converts the communication request to a text message 504 and forwards it to the associated real estate professional 502.

In an exemplary embodiment of the present invention, the text message 504 may reads as “chat request from homes.com. The next msg you will receive is from the prospect (real estate consumer). Simply respond to the prospect to claim the conversation.” Further, the details 506 of communication request is also send to the real estate professional 502.

In an exemplary embodiment of the present invention, the details 506 may read as “Hi, I'd like to schedule a showing on this home tonight. dotsig.io/c/14/Qv8yt|2U”. Thereafter, the real estate professional 502 if interested then response as a text message 508 to the communication request of the real estate consumer. For exemplary purposes, the response message may read as “Hi John, what time?”.

FIG. 6 illustrates a screenshot showing a real estate web platform 600 displaying communication between the real estate consumer and the real estate professional 502. The system converts the text message from the real estate professional to the web communication message 602 and then displays the message on the chat box 604.

The process is then continued where the real estate consumer uses the real estate web platform to communicate with the real estate agent. The real estate agent uses a mobile phone to respond to the messages and thus does not require to have internet and online to communicate with the real estate consumer.

The present invention offers various advantages such as allowing the real estate professional to communicate over mobile network with the real estate consumer. There is no requirement for the real estate professional to be online at the same time to communicate with the real estate consumer. Further, the present invention allows fast communication of the real estate consumer with the right estate professional. Further, the present invention creates competition among the real estate professional to respond quickly to initiate conversation with the real estate consumer.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A machine readable non-transitory medium storing executable program instruction which when executed cause a data processing system to perform a method for allowing real-time communication between real estate consumers and real estate professionals on a real estate web platform, the method comprising the steps of:
receiving a communication request from a real estate consumer for interacting with a real estate professional on a real estate web platform;
extracting the zip code of the real estate viewed by the real estate consumer;
creating a team of real estate professionals belonging to the same zip code;
associating the extracted zip code with the team of real estate professionals of the same zip code;
converting the communication request into a text message;
sending the text message in a hierarchy to each real estate professional of the associated team;
receiving acceptance from the first real estate professional in the hierarchy to communicate with the real estate consumer;
converting the text message received from the first real estate professional into the web communication message; and
displaying the response of the first real estate professional to the real estate consumer to establish the communication.

2. The method according to claim 1 further comprising the step of sending the text message from the real estate consumer to the second real estate professional in the hierarchy on failure to receive the response from the first real estate professional in a pre-defined time.

3. The method according to claim 1 further comprising the steps of:
sending the text message received from the real estate consumer simultaneously to each real estate professional in the team associated with the extracted zip code;
receive a text message response from at least one of the real estate professional from the team; and
convert the text message from the real estate professional into the web chat who responded first and within the pre-defined time to establish communication with the real estate consumer.

4. The method according to claim 1 further comprising the steps of:
send the text message received from the real estate consumer simultaneously to each real estate professional in a first group associated with the extracted zip code;
receive a text response from at least one of the real estate professional from the first group;
convert the text message into the web chat of the real estate professional who responded first and within the pre-defined time to establish communication with the real estate consumer; and
send the text message received from the real estate consumer to each real estate professional in a second group associated with the extracted zip code upon failure to receive response from each real estate professional of the first group within the pre-defined time.

5. A system integrates with a real estate web platform for allowing real-time communication between real estate consumers and real estate professionals, the system comprising:
a server having a real estate professional database for storing data such as zip code of real estate professionals in a hierarchy for responding within a pre-defined time to web chat request initiated by the real estate consumers; a real estate professional team database coupled to the real estate professional database for storing data of one or more teams of real estate professionals in a hierarchy associated with zip codes of a real estate; a real estate professional group database coupled to the real estate professional team database for storing data of real estate professionals in groups in a hierarchy belonging to same zip code of a real estate; and
a software module stored and executed by the server to:
receive a web chat request from a real estate consumer for interacting with a real estate professional;
extract the zip code associated with the real estate for which the real estate consumer initiates the web chat request;
convert the web chat request into a text message;
send the text message received from the real estate consumer in a hierarchy to a first real estate professional associated with zip code of the real estate;
receive acceptance with a text response from the first real estate professional in the hierarchy to communicate with the real estate consumer within the pre-defined time;
convert the text response received from the first real estate professional into the web chat message; and
display the converted text response of the first real estate professional to the real estate consumer to establish the communication.

6. The system according to claim 5 wherein the software module stored on the server and further executed by the server to send the text message received from the real estate consumer to a second real estate professional associated with the zip code in the hierarchy on failure to receive the response from the first real estate professional in the pre-defined time.

7. The system according to claim 5 wherein the software module stored and executed by the server to:
send the text message received from the real estate consumer simultaneously to each real estate professional in the team associated with the extracted zip code;
receive a text response from at least one of the real estate professional from the team; and
convert the text response into the web chat of the real estate professional who responded first and within the pre-defined time to establish communication with the real estate consumer.

8. The system according to claim 5 wherein the software module stored and executed by the server to:
send the converted text message received from the real estate consumer simultaneously to each real estate professional in a first group associated with the extracted zip code;
receive a text response from at least one of the real estate professional from the first group;
convert the text response into the web chat of the real estate professional from the first group who responded first within the pre-defined time to establish communication with the real estate consumer; and
send the text message received from the real estate consumer to each real estate professional in a second group associated with the extracted zip code upon failure to receive response from each real estate professional of the first group within the pre-defined time.

9. The system according to claim 5 wherein the software module stored and executed by the server to:
send the converted text message received from the real estate consumer simultaneously to each real estate professional in a first group of a first team associated with the extracted zip code;
receive a text response from at least one of the real estate professional from the first group associated with the first team;
convert the text response into the web chat of the real estate professional who responded first and within the pre-defined time to establish communication with the real estate consumer; and
send the text message received from the real estate consumer to each real estate professional in a second group associated with the extracted zip code within the same team upon failure to receive response from each real estate professional of the first group within the pre-defined time.
